(19) United States
(12) Patent Application Publication
(10) Pub. No.: US 2021/0326780 A1
(43) Pub. Date: Oct. 21, 2021

(54) INTEGRATED TRAVEL PLATFORM FOR PERSONALIZED TRIP EXPLORATION, PLANNING, AND BOOKING

(71) Applicant: XOKIND, INC., San Diego, CA (US)

(72) Inventors: Yinyin Liu, San Diego, CA (US); Arjun Krishan Bansal, Del Mar, CA (US); Sarah Kimberlin Harris, San Diego, CA (US); Scott Leishman, San Diego, CA (US); Anne Devine, La Jolla, CA (US); Marcus Ng, New York, NY (US); Ajay Sudhakar Deshpande, San Diego, CA (US); Shaowei Png, San Diego, CA (US); Avinash Pujala, Richmond, VA (US); Gabriel Pereyra, San Diego, CA (US)

(21) Appl. No.: 17/234,046

(22) Filed: Apr. 19, 2021

Related U.S. Application Data
(60) Provisional application No. 63/012,014, filed on Apr. 17, 2020.

(51) Int. Cl. G06Q 10/02; G06Q 30/02; G06Q 20/02; G06F 3/0484; G06N 3/02

(52) U.S. Cl. CPC G06Q 10/025; G06Q 30/0203; G06N 3/02; G06F 3/04847; G06Q 20/02

(57) ABSTRACT

Methods, devices and systems for improving travel planning, booking and viewing using an integrated travel platform are described. An example method includes presenting, by an integrated electronic travel platform to a user, a profile comprising a plurality of fields to receive a set of parameters associated with a trip that comprises a plurality of modalities, analyzing, using a shared ontology data structure, the profile to determine a plurality of options for each of the plurality of modalities, wherein each of the plurality of options conforms to the set of parameters for the corresponding modality, presenting, to the user, the plurality of options, receiving, from the user, a plurality of selections corresponding to one option from the plurality of options for each of the plurality of modalities, performing, while remaining within the integrated electronic travel platform, a booking operation for each of the plurality of selections.

### CROSS-REFERENCE TO RELATED APPLICATION

This patent document claims priority to and benefit of U.S. Provisional Patent Application No. 63/012,014, filed on Apr. 17, 2020. The entire content of the before-mentioned patent application is incorporated by reference as part of the disclosure of this patent document.

### TECHNICAL FIELD

This patent document generally relates to an integrated platform for travel itinerary planning, booking and viewing.

### BACKGROUND

Users typically rely on multiple websites and/or platforms to plan or book various trip components, and construct or organize their itineraries. They invariably have to switch among the websites, and enter (and even re-enter) their search and personal information, adhere to different formats and data entry requirements, provide payment information multiple times (and with perhaps multiple means of payment), and perform other redundant operations. In addition, these disparate sites lack coordination, and cannot keep track and propagate changes that may be made in one aspect of the travel itinerary to other aspects of the travel itinerary. Therefore, there is a need to improve the overall planning and travel experience.

### SUMMARY

Embodiments of the disclosed technology relate to providing an integrated platform, including a graphical user interface (GUI), for travel itinerary planning, booking, viewing and other features and benefits that are disclosed herein. The disclosed embodiments can, for example, be used in every aspect of the travel experience, thereby eliminating the need to interact with multiple and disparate platforms for specific aspects of the travel experience.

In an example aspect, the integrated platform allows the application of filters and profiles for different trip types, destinations and traveler segments for the user or groups of users.

In another example aspect, a method for using an integrated platform for travel planning, booking and viewing is disclosed. The method includes selecting a profile associated with the trip and a set of trip parameters comprising an anchor location, a start date, and an end date, the trip comprising a plurality of modalities that include one or more of a meal, a lodging, an activity and a transportation, wherein the anchor location corresponds to a focal point of the trip and the profile corresponds to a purpose of the trip, selecting a price range for one or more of the plurality of modalities, exploring a plurality of options for each of the plurality of modalities, wherein each of the plurality of options conforms to the profile, the set of trip parameters, and the price range for the corresponding modality, selecting, while remaining within the integrated travel platform, exactly one of the plurality of options for each of the plurality of modalities, and viewing an itinerary of the trip, wherein the exactly one of the one or more options are confirmed or booked, while remaining within the integrated travel platform, prior to the viewing the itinerary of the trip.

In yet another example aspect, a method for improving travel planning, viewing, and booking is disclosed. The method includes presenting, by an integrated electronic travel platform to a user, a profile comprising a plurality of fields, receiving, using the plurality of fields, a set of parameters associated with a trip, the parameters comprising an anchor location, a start date, and an end date, the trip comprising a plurality of modalities that include one or more of a meal, a lodging, an activity and a transportation, wherein the anchor location corresponds to a focal point of the trip and the profile corresponds to a purpose of the trip, receiving, from the user, a price range for one or more of the plurality of modalities, analyzing, using a shared ontology data structure, the profile to determine a plurality of options for each of the plurality of modalities, wherein each of the plurality of options conforms to the set of parameters and the price range for the corresponding modality, presenting, to the user, the plurality of options, receiving, from the user, a plurality of selections corresponding to one option from the plurality of options for each of the plurality of modalities, performing, using at least one third-party application programming interface (API) while remaining within the integrated electronic travel platform, a booking operation for each of the plurality of selections, generating, based on the booking operation, an itinerary of the trip, presenting, to the user, the itinerary.

In yet another example aspect, a graphical user interface (GUI) in an integrated platform for travel planning, booking and viewing is disclosed. The GUI includes a first screen, comprising a plurality of fields configured to receive each of a set of parameters associated with a trip, the parameters comprising an anchor location, a start date, and an end date, the trip comprising a plurality of modalities that include one or more of a meal, a lodging, an activity and a transportation, wherein a profile comprises the plurality of fields, and wherein the anchor location corresponds to a focal point of the trip and the profile corresponds to a purpose of the trip, a slider to select a price range for one or more of the plurality of modalities, and one or more buttons to select a profile associated with the trip, a second screen, comprising a plurality of options for a corresponding modality, wherein each of the plurality of options conforms to the set of parameters and the price range for the corresponding modality, wherein the plurality of options are determined based on a neural network, and wherein the second screen enables a selection of one option of the plurality of options for each of the plurality of modalities, a third screen, comprising a list comprising the one option of the plurality of options selected for each of the plurality of modalities, the list enabling a user to perform a booking operation using at least one third-party application programming interface (API) while remaining within the integrated electronic travel platform, wherein at least one entry of the list comprises a price for the corresponding modality, and a fourth screen, comprising a vertical timeline to view an itinerary of the trip, wherein the booking operation is performed prior to viewing the itinerary of the trip.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 illustrates a flow diagram for an integrated travel platform.

FIG. 2 illustrates an example of a GUI menu screen of an integrated travel platform.

FIGS. 3A and 3B illustrate flowcharts of example uses of an integrated travel platform.

FIG. 4 illustrates an example of a GUI for updating a trip preference profile for a user.

FIG. 5A illustrates an example of the ontologies that organize the user and travel options.

FIG. 5B illustrates an example of the ontologies shown in FIG. 5A being used to recommend a restaurant to a user based on matching properties.

FIG. 6 is an example of a recommendation system that uses feature representations that enable a model to predict user preferences.

FIGS. 7A-7C illustrate examples of a GUI for presenting visual quizzes to determine user preferences for different modalities.

FIG. 8A illustrates an example of a GUI for multiple personalized recommendations.

FIG. 8B illustrates a particular recommendation

FIG. 8C illustrates an example of user input for the recommendation in FIG. 8B.

FIGS. 9A and 9B illustrate examples of a GUI for travel exploration.

FIGS. 10A and 10B illustrate examples of a GUI for exploring previous trips.

FIG. 11 illustrates an example of a GUI for trip planning that uses anchors and trip preference profile.

FIG. 12 illustrates an example of a GUI for presenting options in a condensed form so that the user can compare the options.

FIGS. 13A-13C illustrate examples of a GUI for presenting the options of FIG. 12 in more detail to the user.

FIG. 14 illustrates an example of a horizontal carousel for a specific trip modality.

FIG. 15 illustrates an example of a GUI for presenting a map to a user to explore different modalities in close proximity to a selected point of interest or activity.

FIGS. 16A-16C illustrate examples of a GUI for presenting a user with pre-packaged itineraries to explore in varying levels of detail.

FIGS. 17A and 17B illustrate examples of a GUI for enabling a user to explore a trip modality using a natural language search.

FIGS. 18A and 18B illustrate examples of a GUI for planning a trip using a list view or a map view, respectively.

FIG. 19A illustrates an example of a GUI for trip planning.

FIG. 19B illustrates the continuation of the trip planning GUI from FIG. 19A.

FIG. 20A illustrates an example of a tile for one modality of the trip.

FIG. 20B illustrates an example of a detailed view of the tile in FIG. 20A.

FIGS. 21A-21E illustrate an example of a GUI for manually adding a stop to an itinerary.

FIGS. 22A and 22B illustrate examples of GUI for displaying options from an anchor point in the planning component of the integrated travel platform.

FIGS. 23A-23D illustrate an example of a GUI for multiple travelers editing an itinerary.

FIG. 24 illustrates an example of a GUI for trip booking.

FIG. 25 is a block diagram of an example of a hardware platform for implementing a method or technique for using an integrated travel platform.

FIG. 26 is a flowchart of an example method for using an integrated travel platform.

FIGS. 27A and 27B illustrate a flowchart of an example method for improving travel planning, viewing, and booking using an integrated travel platform.

### DETAILED DESCRIPTION

Users typically interact with several products, web sites and services when planning, booking and sharing a trip or travel experience. Searching for travel ideas based on their preferences and interests, then planning among multiple stops and places that are used to create an itinerary with other travelers, and finally finding and booking an appropriate flight, hotel, rental car, etc. This experience normally necessitates switching between a multitude of products, websites and services, and entering personal information, financial information, and other types of information, multiple times for each of the different products or websites. Furthermore, during the trip, users look through separate confirmation emails or booking histories in these disparate products, websites and services as they navigate through their itineraries.

Section headings are used in the present document to improve readability of the description and do not in any way limit the discussion or the embodiments (and/or implementations) to the respective sections only.

1 Overview of the Integrated Travel Platform

Embodiments of the disclosed technology include an integrated platform (e.g., a website, a mobile application, a software program, etc.) that, among other features and benefits, incorporates a large number of these functionalities through a coherent user interface, and provides the user, or a group of users, with a significantly improved travel experience that spans personalized planning and exploration, booking, experiencing the trip, and sharing trip highlights (e.g., images, websites, videos) with family and friends. As the user interacts with the integrated platform through the trip planning process, filter configurations and search queries, it understands the user's preferences over time, and makes more and more personalized recommendations. The integrated travel platform tracks new stops and any needed scheduling changes, facilitates auto-planning and auto-rescheduling, and propagates those changes to other aspects of travel planning, including modified personalized recommendations, modified scheduling bookings, and other modifications to the itinerary.

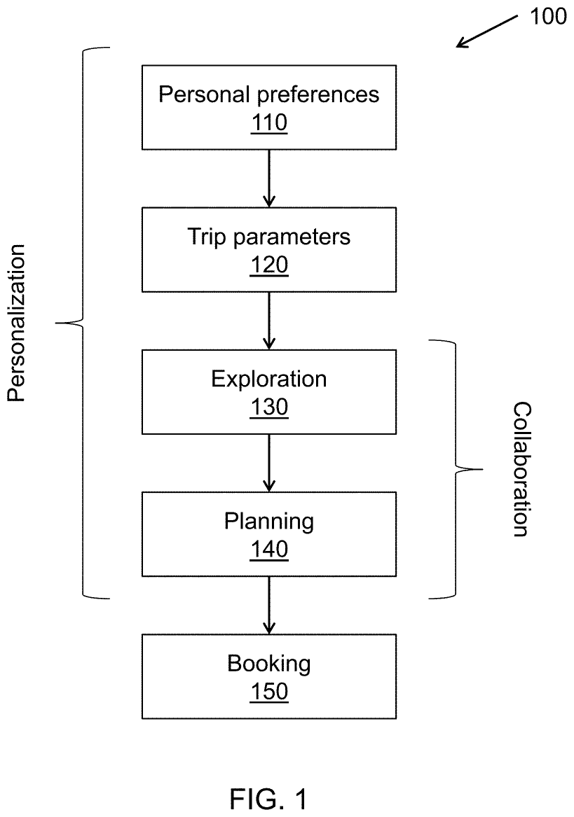

In some embodiments, the integrated travel platform is implemented using the modules, or components, illustrated in FIG. 1. As shown therein, the integrated travel platform 100 includes a personal preferences module 110, a trip parameters module 120, an exploration module 130, a planning module 140, and a booking module 150. As discussed above, the integrated travel platform provides a unique level of personalization, both at the start of the journey planning stage as well as during the trip, that is integrated into the personal preferences module 110, the trip parameters module 120, the exploration module 130, and the planning module 140. The exploration module 130 and the planning module 140 are also configured to enable collaboration between multiple trip participants. Each of these modules will be further described in other sections of this patent document.

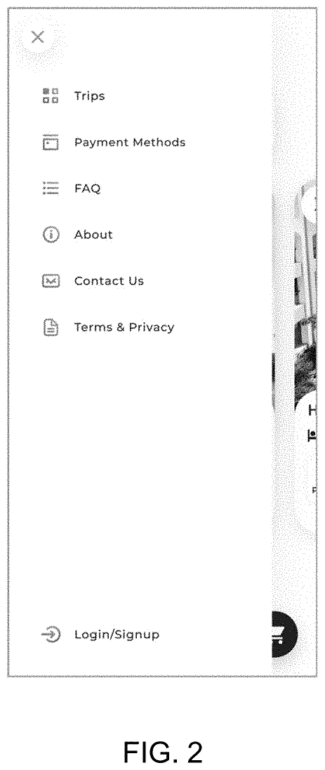

In some embodiments, the integrated travel platform may be opened with the example menu screen illustrated in FIG. 2. As shown therein, the menu options include Trips (which can further expand into different options, e.g., exploring, planning and booking), Payment Methods (which can support credit cards, PayPal, Venmo, and the like, and where the user can manage their saved payment information), Frequently Asked Questions (FAQs), and additional contact and legal information. In an example, the Login/Signup option may be given so that a user that has created an account through a desktop computer can log into the mobile application (or vice versa). In another example, the user could be automatically logged in, and the Login/Signup option can be replaced with a Logoff option.

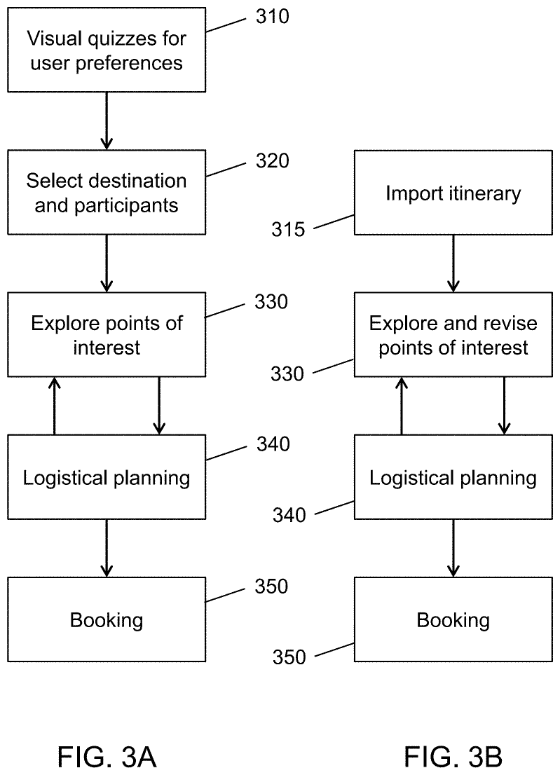

In some embodiments, as illustrated in FIG. 3A, a user may begin by engaging in multiple visual quizzes, which will enable the integrated travel platform to better understand the user's preferences (310). The user may now select one or more destinations and other travelers that are planning on joining the user on the trip (320). Once a destination is selected, the integrated travel platform that has incorporated some of the user's preferences, can present a number of points of interest for the user to explore (330). In an example, these points of interests can be explored and then either selected or dismissed. In another example, the user can add any other points of interest that were not initially available. These user interactions will further assist the integrated travel platform in understanding the user's preferences.

Once the points of interest have been selected, the user can move on to logistical planning (340), wherein the user can now explore and select accommodations, dining options, and/or travel arrangements. Since most logistical planning will typically affect an itinerary, the planning (340) and exploring (330) operations are performed iteratively until the user settles on a final itinerary, which is when the user can proceed to the booking operation (350), while remaining within the integrated travel platform.

In some embodiments, as illustrated in FIG. 3B, a user can begin the travel process by using the GUI to browse pre-generated itineraries for certain destinations, local regions, or road trips (315). The user can then continue to process by exploring (330) things to do, places to stay and eat, etc. that were not part of the pre-generated itinerary. As described in the context of FIG. 3A, this is followed by the logistical planning phase (340), which is iteratively performed with the exploration phase (330) until a final itinerary is decided upon by either the user or the user and other travelers. This is followed by the booking operation (350).

In some embodiments, the exploration (330) and planning (340) phases are configured around an anchor location, which is a geolocation associated with trip. A major stop in the trip can be designated as an anchor location, such that other modalities (e.g., accommodation and dining options) closer to the anchor location are preferred during exploration and planning.

As the user navigates through the different stages described in FIGS. 3A and 3B, the user remains within the integrated travel platform, which advantageously eliminates the need to interact with multiple and disparate platforms for specific aspects of the travel experience. Each of the operations described in FIGS. 3A and 3B are further detailed in the following sections.

2 Examples of Building User Profiles and User Preferences

In existing travel reservation systems, users need to enter their traveler information every time and for every product, website or service that is used to plan and/or book each aspect or component of a trip. This problem is exacerbated when multiple users are traveling together. Furthermore, each of the multiple users may have their own preferences for planning and booking different trip types, which is rarely accounted for in existing travel reservation systems.

Embodiments of the disclosed technology recognize that each consumer has certain patterns of selecting accommodations, flights and other trip components when they travel solo, for work, with their spouse, with their entire family, etc. This consistency is captured in a user profile and then reused for future trips.

In some embodiments, a user profile can include a main travel profile that is seeded with pre-populated filters that have been previously provided by the user or obtained by third-party affiliates. In the process of planning and booking, the main travel profile can be customized and stored as more specific profiles (e.g., solo trip, recurring business trip to a certain location, annual family vacation, etc.). These customized profiles are shareable and easily reusable for future trips. In an example, if User A is part of a larger group of users planning a trip, User A can send one of his/her customized profiles to the administrator of the larger group of users, and his preferences are automatically considered when the group bookings are made.

In some embodiments, a user profile can be extracted and built from the user data that has been previously shared with third-party sources, which includes their travel and booking histories, content they share and follow on social media, and other e-commerce sites. Based on their histories and choices from other products, the integrated travel platform can extract their preferences related to travel, budget level, experience, visual and style preferences.

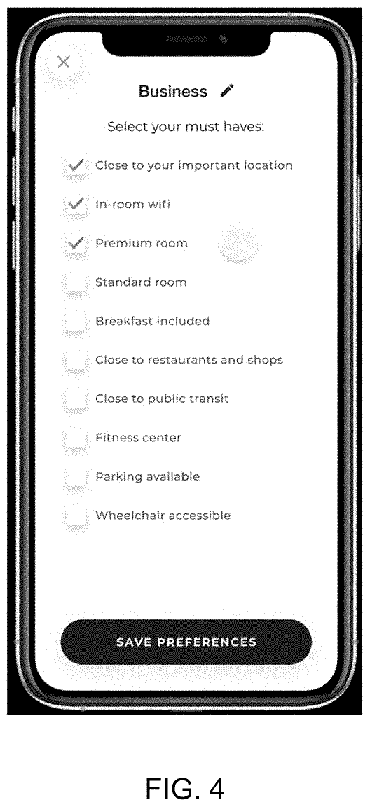

An example of selecting features of a travel profile for a user is illustrated in FIG. 4. As illustrated in FIG. 4, which is an example of a business profile, various features are pre-selected as “must haves” for convenience, which can then be customized by the user, and subsequently used to filter the available options presented in the options in the exploring component.

In some embodiments, travel profiles can be grouped or combined in order to simplify the planning process. In an example, the “must haves” of multiple travelers may be combined in order to find available options that satisfy the preferences of each of the travelers. In another example, only common weaker preferences may be taken into account in order to display available options for any stop in the exploration phase.

In some embodiments, the main travel profile and the customized travel profiles for a particular user can be refined or updated in the backend through collecting implicit user signals. In an example, analytics for user interactions with the integrated platform can be leveraged to refine the recommendations presented to the user. In an example, the view time with respect to any content or any view in the platform can be measured to determine what the user is interested in and focusing on (e.g., using the ⅓ and ⅔ lines on the screen as markers). In another example, the current index of the carousel can be used to measure the view time with respect to available options for a particular stop. In yet another example, the view time of the horizontal carousel can be tracked based on which card is in view (e.g., which widget is present at a particular screen location). In yet another example, user clicks and/or taps used to examine details for specific options may be used to update or refine the main travel profile and/or the customized travel profile.

In some embodiments, visual and textual quizzes can be used to collect user preferences during user signup and onboarding. The quizzes can be designed considering the taxonomy or ontology of the travel content and options at a destination, so that the integrated platform can use the user answers during the exploration and planning stages to narrow down to more relevant options when existing user information and preferences are minimally available.

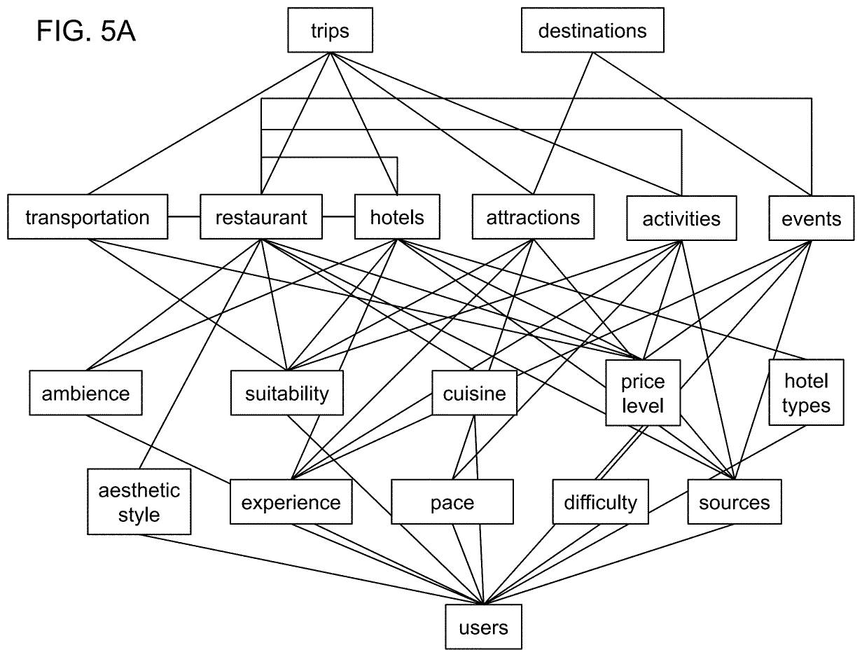

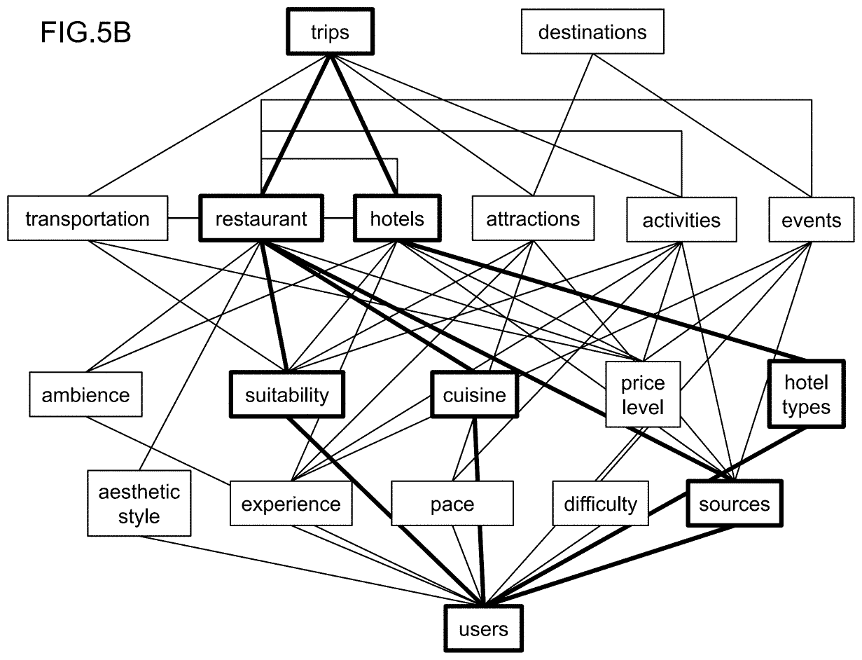

In some embodiments, the taxonomy and ontology of the travel content are defined from the perspective of user's preference and the factors that drive the user's choice. The travel options are categorized and mapped into this purpose-built ontology in order to measure how well the options match the user's preference. In an example, a food and drink establishment is defined with properties including cuisine types, price level, whether it is suitable for kids and pets, which source of information (travel articles or experienced traveler content) has highly rated it before, nearby attractions, and nearby accommodation options. On the user side, the user's preference includes their preferred cuisine type, typical price level, who they are travelling with, trusted source of information, preferred attraction types and accommodation types. By organizing travel options and user's preferences using a shared ontology system, the integrated travel platform can measure the matching level of travel options across all modalities with the user, and accordingly narrow down and rank the options to provide recommendations. FIG. 5A illustrates an example of the ontologies that organize the user and travel options.

FIG. 5B illustrates an example of a restaurant that is recommended to a user due to matching properties in suitability, cuisine type, highly rated by a source for its unique features, and proximity to a hotel that matches the user's hotel preference. As shown therein, only a subset of the classes, instances, properties, and relations of the ontology shown in FIG. 5A are used because only a restaurant is being recommended to the user.

Using the shared ontology data structure (e.g., an example of which is illustrated in FIG. 5A), which defines relationships from the user side (e.g., the “user” block connecting to properties that include “cuisine”, “price level”, “experience”, etc.) as well as from the side of the factors that drive the user's choices (e.g., the “trips” and “destinations” blocks), enables the integrated travel platform to measure the matching level of travel options across all modalities in a computationally efficient manner, resulting in user recommendations.

In some embodiments, the recommendation is commonly driven by a combination of ontology-based recommendation and neural networks-based approach. For entities that cannot be organized by an ontology but by feature vectors or a combination of feature representations, and when user's preference is implicit, a neural network model is used to predict the likelihood that a user will choose an option.

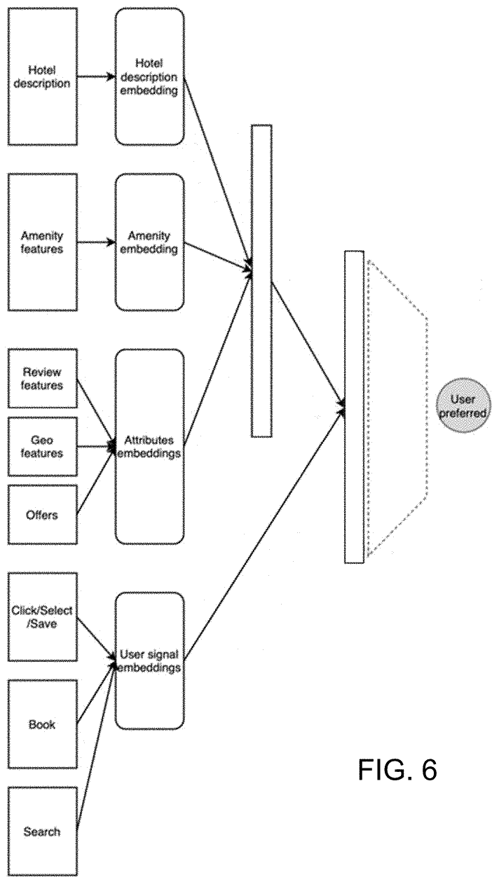

FIG. 6 illustrates an example of a recommendation system that uses a set of feature representations for a hotel and the model will learn to predict whether it matches user's preference through user's interactions including user selection, search queries, and booking events. As shown therein, various features are represented using embeddings, and then the similarity between the embeddings is quantified to generate a user recommendation.

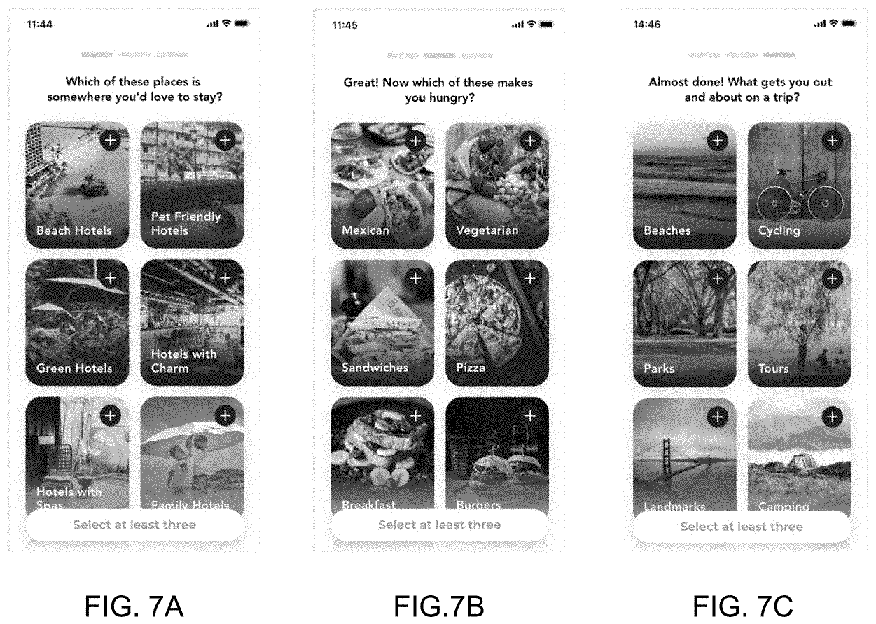

In some embodiments, visual quizzes (as compared to explicit questionnaire-style quizzes), examples of which are illustrated in FIGS. 7A-7C, can be used to ascertain implicit user preferences that are typically hard to articulate or determine. In an example, contents or pictures can be algorithmically grouped into pairs or sets with contrasting features to gauge the user's interest (similar to the previously described aspect of presenting disparate options in the horizontal carousel when existing user information and preferences are minimally available).

In some examples, the visual quizzes may be used to determine user preferences for which aesthetic style of hotel a user prefers (FIG. 7A), what kind of foods are preferred (FIG. 7B), and what activities or level of physical exertion a user prefers (FIG. 7C). In an example, a fun fact may be presented with the visual quiz.

In some embodiments, the visual quizzes taken by multiple users may be used to update and refine their individual profiles, as well as measure the compatibility between sets of users. This will advantageously enable the integrated platform to suggest one set of activities (e.g., a hike or trek) for one group of users and another set of activities (e.g., movies and shopping) for another group of users.

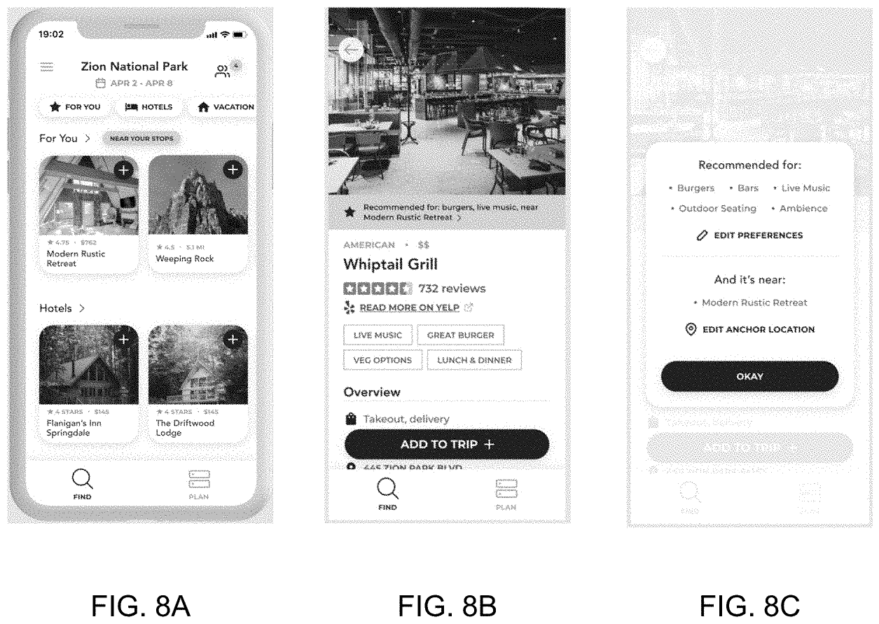

In some embodiments, the platform uses the quiz results and user's interactions to learn and generate personalized recommendations, surfacing information with personalized rankings. In an example, as illustrated in FIG. 8A, the exploration component shows a collection of personalized recommendations across multiple modalities in a “For You” carousel. The platform also provides multiple ways for the user to signal their positive and negative feedback on personalized recommendations. In an example, the user can remove an option from the “For You” carousel. In another example, the user can give a thumb-up or thumb-down to the options.

In some embodiments, the platform provides the user with a specific recommendation (as illustrated in FIG. 8B), as well as why that option is recommended with reasons including user's preference and profile, or proximity to one or more anchor locations, as illustrated in FIG. 8C. When the user removes an option from “For You” or gives a thumb-down, the user can choose the reason behind the negative feedback, which is used to improve the personalization aspect of the integrated travel platform.

In some embodiments, the personalized recommendations or personalized rankings are also influenced by the trip type, purpose of the trip, co-travelers' interactions with the platform or the user's favorite sources of travel information.

3 Examples of Exploring Elements of the Trip

Embodiments of the disclosed technology describe various ways for a user to explore different modalities of a trip.

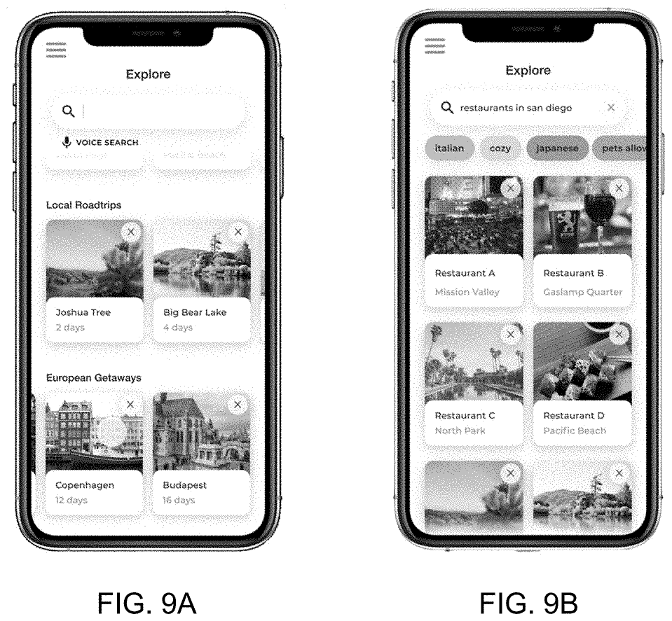

In some embodiments, as illustrated in FIG. 9A, the integrated travel platform includes a GUI screen from where the user can explore, search and find for travel itineraries. A more targeted approach can be used, as illustrated in FIG. 8A, where the user can explore and find options for stay, eat and do in various categories for a specific destination. In other embodiments, as illustrated in FIG. 9B, the user can search and browse the restaurant category. These GUIs enable a user to explore different options at a certain place, either locally or far afield. The user can add any option into the itinerary from here, or open an individual option to view details and add into trips there, illustrated in FIG. 8B, using the “ADD TO TRIP+” button.

In some embodiments, the user can leverage social media posts, posts by influencers, and travel blogs and magazines to explore where their next vacation might take them. This content is presented to the user in the GUI as pre-generated itineraries. As illustrated in FIG. 9A, the user can use either voice or text inputs to search, as well as explore the itineraries (e.g., local road trips, European getaways). In other embodiments, the user can extract travel content from a travel blog or travel magazine utilizing a backend system, by leveraging database lookup, or querying third-party travel and geolocation APIs. In an example, the integrated travel platform can extract the aforementioned travel destinations, attractions, food/drink, activities and experience recommendations, create entities and populate its details, and construct an itinerary using the sequence of modalities.

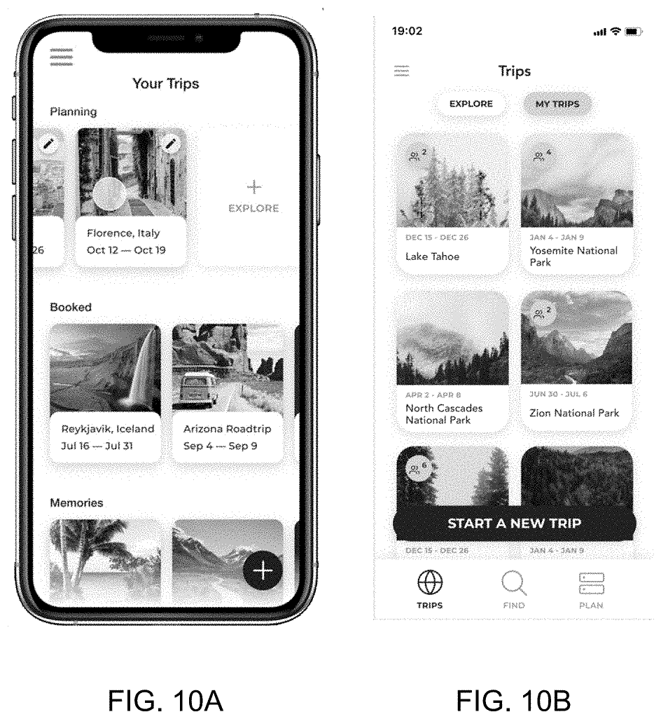

In some embodiments, the user can engage in viewing all their own trips, which includes updating, sharing or reviewing upcoming trips, and browsing and sharing content from previously taken trips, as illustrated in FIGS. 10A and 10B. The examples therein illustrate the “My Trips” screen that includes all the trips being planned or have taken before, and wherein the numbers in circles in the upper left of a card indicate how many collaborators are in that trip.

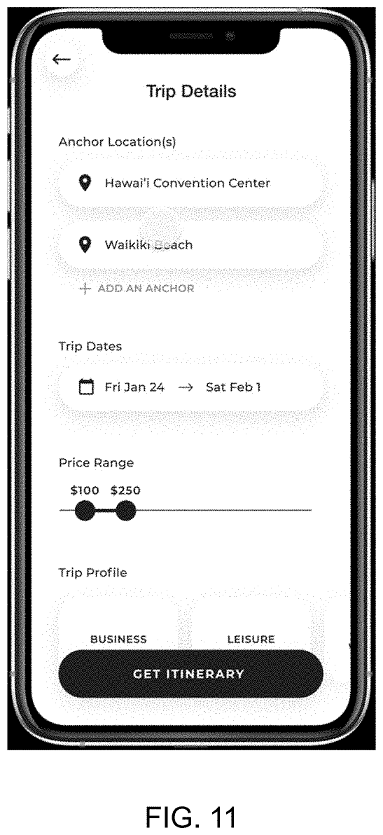

Having selected an option from either FIG. 8A or 9A, the user is then presented with the screen illustrated in FIG. 11, which allows the user to plan a trip by inputting additional basic trip details and parameters. The user can also provide more contextual information, including the trip type, how many co-travelers, the purpose of the trip, and budget allowed. The user can choose to use a profile to customize the trip experience and save to reuse this for future similar trips, as illustrated in the example profile in FIG. 4.

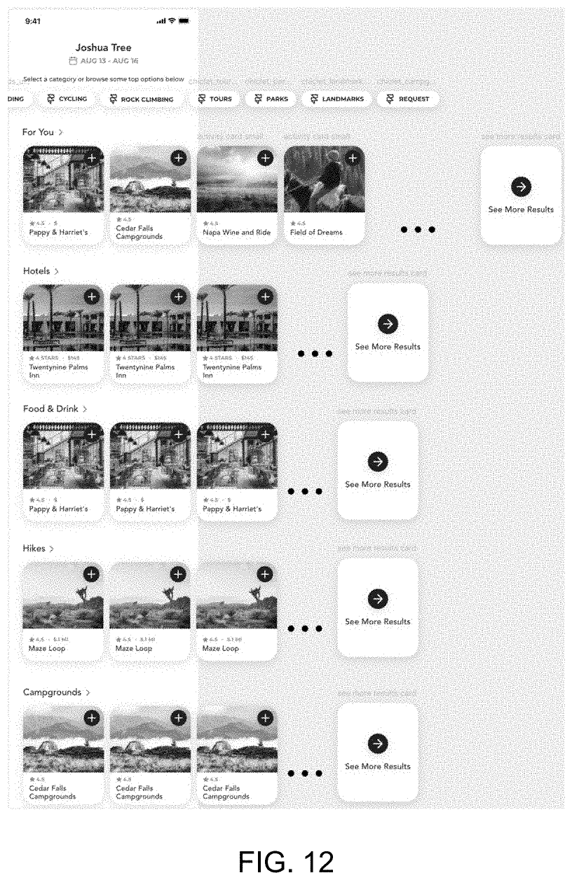

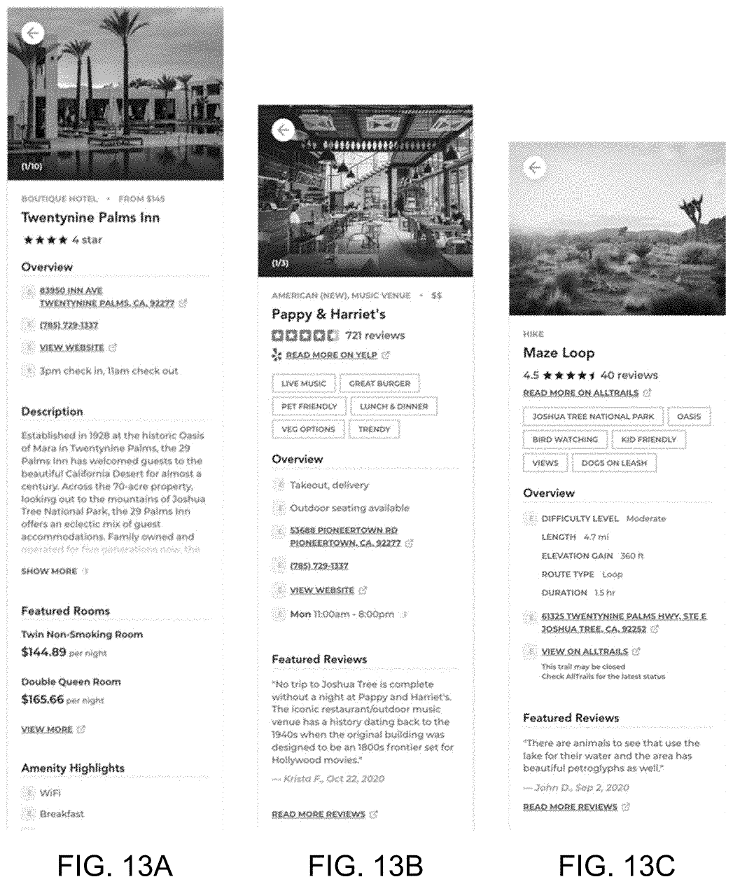

Once the basic trip parameters have been set, the user is presented with options for each stop/element/modality of the trip, e.g., outbound/returning flight segment, hotel options, other types of accommodations, various types of activities and attractions, and food and drink options. The exact list of categories to present can be dynamic based on what that destination offers. Examples of GUIs that present the user with these options are illustrated in FIG. 12. As shown therein, the GUI lets the user view the option in a condensed form, with only salient details, so options can be compared, but also lets the user explore each option in more detail, as illustrated in FIGS. 13A-13C.

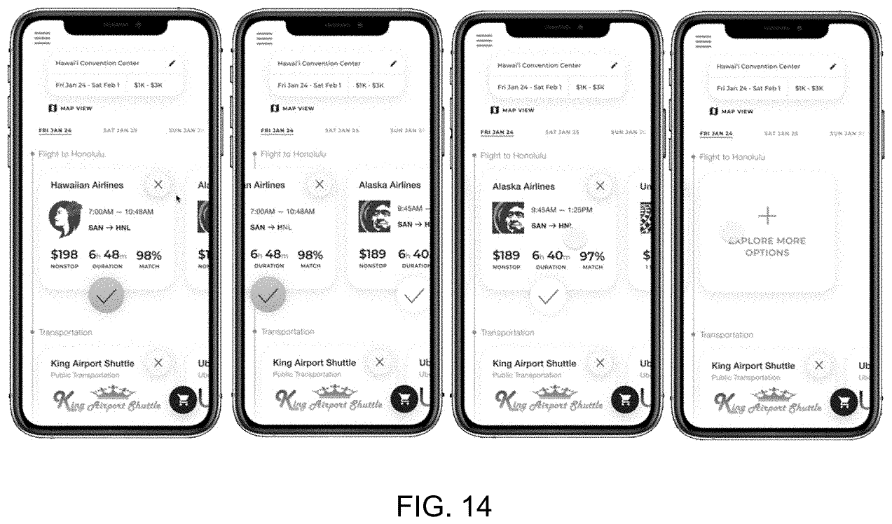

In some embodiments, the user can choose to explore more options using the last card at the end of the carousel (e.g., an “explore more options” tile as illustrated in FIG. 14, which shows the screen of the GUI as the user swipes left).

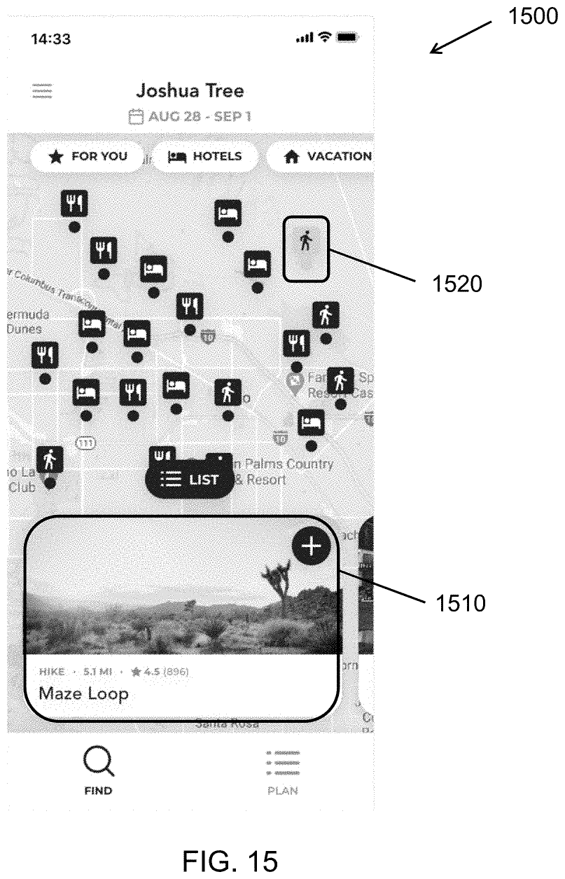

In some embodiments, the user can explore these options on a map on a screen 1500 of the GUI, and initiate re-search by panning and zooming in/out on the map, as illustrated in FIG. 15. As shown therein, the “Maze Loop” card (1510) is currently selected and highlighted on the map (1520). In addition, other relevant modalities that are near the currently selected “Maze Loop” are shown on the map with their corresponding icons.

Once the user selects options into their trip, they can arrange and schedule things into different days of the trip or an unscheduled list, using either a list view or a map view, as will be described further in the next section (Section 4) of this document.

Finally, once bookable options have been selected, the user can book the selected travel itinerary, which is further detailed in Section 5 of this document.

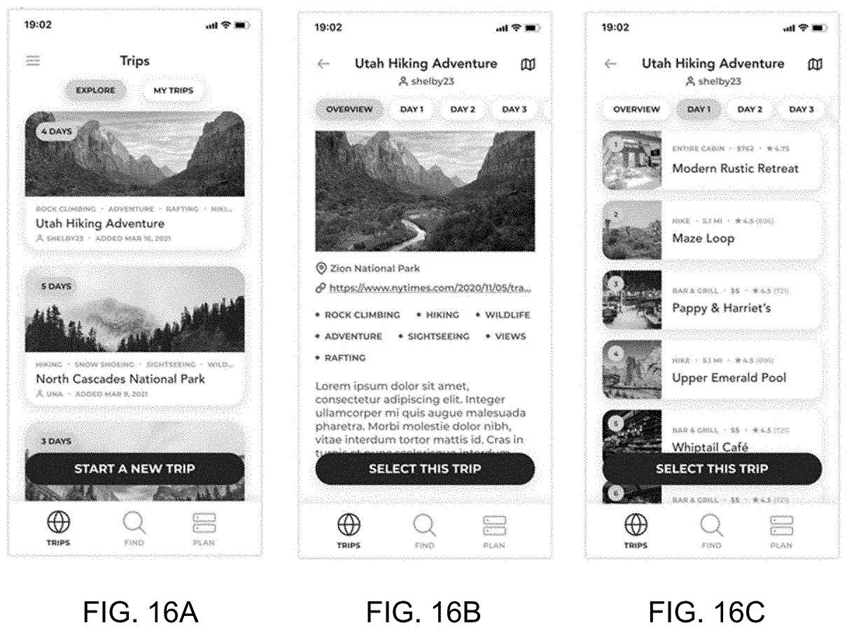

In some embodiments, as discussed earlier, users can explore pre-packaged trips and public itineraries. FIGS. 16A-16C illustrate examples of a GUI for presenting a user with pre-packaged itineraries to explore in varying levels of detail. As shown in FIG. 16A, the user can explore entire trips or itineraries for different trips. The user can then get an overview for a particular itinerary, as shown in FIG. 16B, and even explore a day-by-day itinerary, as shown in FIG. 16C. In an example, users can share their own itineraries, in any level of detail, as travel creations, which will be incorporated into the integrated travel platform. A user can add the entire trip or itinerary as-is, or can add or delete stops and modalities based on their preference.

In some embodiments, the user can add stops or modalities into a pre-packaged itinerary that were obtained from travel inks from external social sites. In this example, the user browses external travel sites and blogs from within the integrated travel platform, thereby enabling any information to be incorporated directly and accurately into the pre-packaged itinerary being explored by the user. Since information (e.g., destinations, accommodations, etc.) from multiple users is available within the integrated travel platform, any missing information can be filled in if that information is available from another travel creation. Similarly, based on the personalization for a user, different modalities may be suggested to the user that were not available in the originally selected pre-packaged itinerary.

In some embodiments, a user can explore all accommodations, activities, and dining options that are close to a destination or anchor point, or within a region. In an example, the anchor point or region can be selected by the user. In another example, the region can be suggested by the integrated travel platform based on an anchor point selected by the user and the personalization model generated for that user. In yet another example, the integrated travel platform can select an anchor point based on the personalized model and the profile selected for a particular trip (e.g., a profile for a business trip as shown in FIG. 4), and then display all the accommodations, activities, and dining options that are close to the anchor point.

In some embodiments, the user can explore options on a map (e.g., as shown in FIG. 15) in the context of other stops in the current trip and any anchor locations selected.

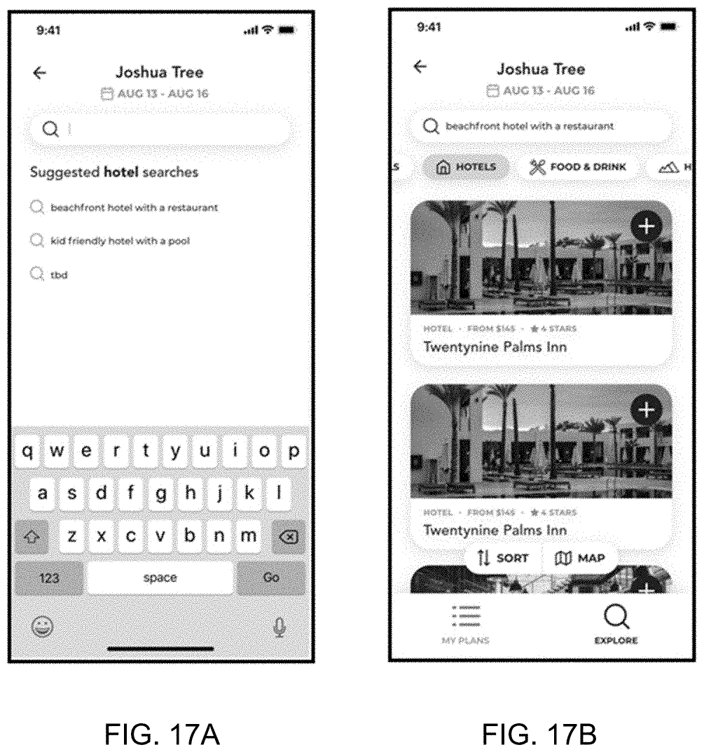

In some embodiments, the user can use a natural language search to explore options, as illustrated in FIGS. 17A and 17B. As shown in FIG. 17A, the user can explore using natural language searches such as “beachfront hotel with a restaurant” or “kid friendly hotel with a pool,” and can then browse the results as a list (as shown in FIG. 17B) or on a map. Since the natural language searches from each user are made within the integrated travel platform, the accuracy of the underlying natural language processing can be improved.

In some embodiments, the exploring options described above can be complemented with user custom-defined stops. In an example, a custom-defined stop can be included from another itinerary or a specific recommendation from another user or itinerary. In another example, the custom-defined stop is a place that the user has in mind, but cannot find a particular entity from the exploration options. In this scenario, the user can enter an arbitrary geolocation using a name or address, and add it to the itinerary.

4 Examples of Planning Elements of a Trip

The integrated travel platform described in this document facilitates the planning of an itinerary, which has been generated using one or more of the above described exploring options, from within the integrated travel platform itself. This advantageously enables the user to switch back-and-forth between the exploring component and the planning component because specific details that are available in the planning component may result in a user exploring further and select another option.

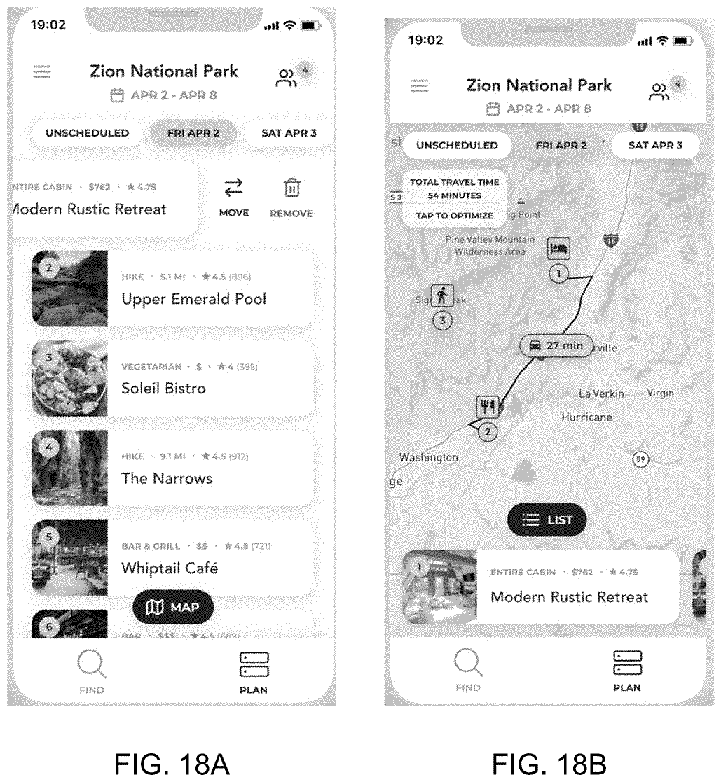

In some embodiments, the planning component (e.g., managing the trip itinerary) uses the GUI illustrated in FIGS. 18A and 18B, which uses a list view and a map view, respectively, to capture the user's saved and scheduled stops.

The user can view, re-order, schedule and reschedule all the stops in the itinerary. The user can scroll through the trip elements as they would occur during the trip within a day and throughout the whole trip, therein capturing the multiple modalities of the planning process, e.g., accommodations, transportation, experiences or activities, meals, flights, and the like.

In some embodiments, and for a longer trip spanning multiple days, the user interface can be configured to show the dates at the top of the screen, and selecting a particular date will scroll and display the vertical timeline for the selected date.

The user can view the locations of stops within a day or throughout the whole trip over a map, with related travel information between stops. In an example, the user can manually reorder the sequence to optimize the travel time or travel distance. In another example, the user can use the algorithmic planning feature to perform the reordering process.

In some embodiments, the user can add time information for the stops in the list if they need to make sure to arrive at a certain stop by a certain time. The planning view can also help the user to sort the stops based on added times and provide arrival time estimate given durations of previous stops and travel time among stops.

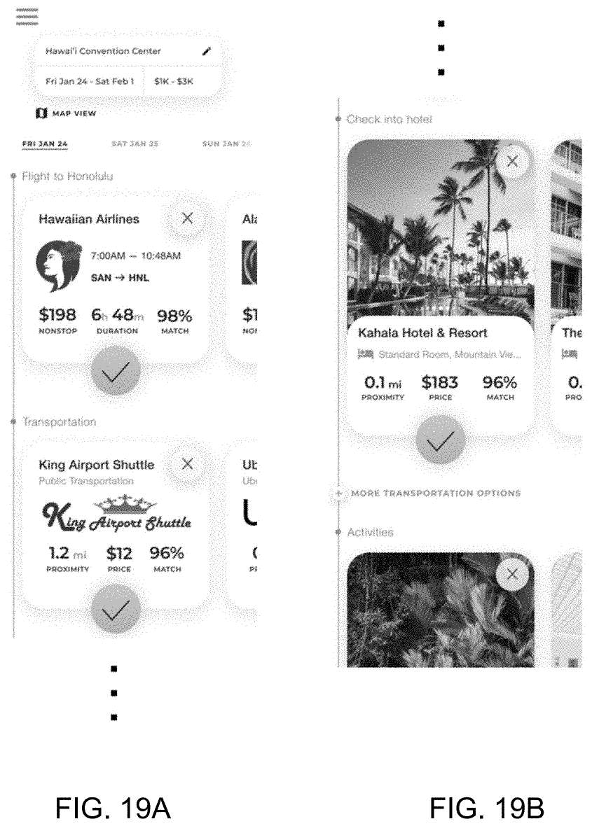

In some embodiments, the user can use the planning component (e.g., setting up the trip itinerary) to show a few recommended and personalized options using the graphical user interface (GUI) illustrated in FIGS. 14, 19A and 19B, which include a vertical timeline view and a horizontal carousel view for the available options. The horizontal carousel view illustrated in FIGS. 14, 19A and 19B comprises a series of tiles that the user can scroll through, and which present the available options for that particular modality of the trip. In some embodiments, the vertical timeline and the horizontal options are collapsible or expandable. In some embodiments, the collapsible version can be configured to visually resemble an accordion. In an example, the tile (or card) shows a condensed version of the relevant information when a portion of the timeline and the available options of that particular modality.

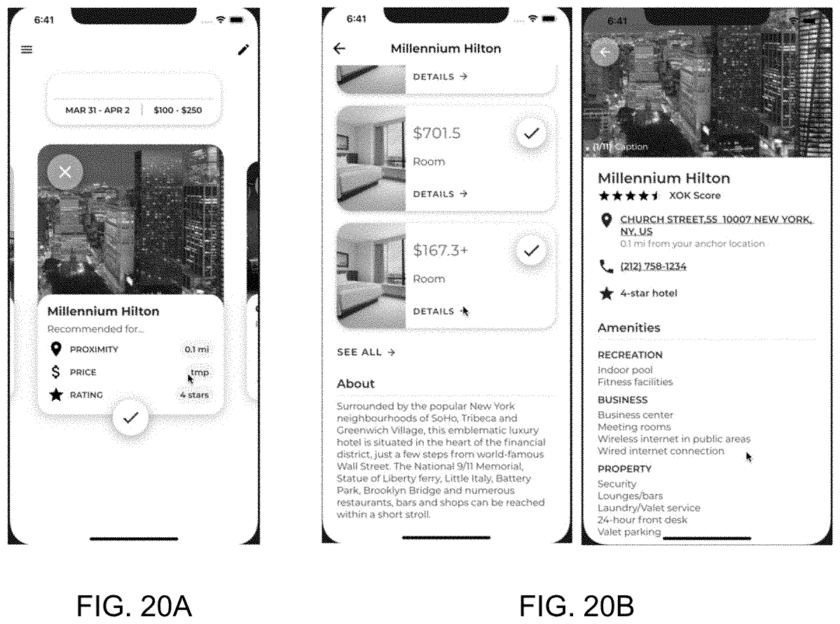

In some embodiments, a specific card (or tile) in the horizontal carousel (e.g., the basic and salient information for the Millennium Hotel, which include the proximity to an anchor location, a price range and a rating, or special attributes, are illustrated in FIG. 20A) may be tapped to show all the relevant details across one or more tiles, as illustrated in FIG. 20B (e.g., specific room options and more detailed information about the Millennium Hotel, as well as contact information and available amenities are shown in the detailed view). The details for a restaurant and for an activity are illustrated in FIGS. 13B and 13C, respectively.

In some embodiments, when one of the options in the horizontal direction for one or more trip modalities is selected (or finalized), the selected option is pinned on the vertical timeline. In other embodiments, the selected option may be put into a shopping cart (as described later in Section 5).

In some embodiments, the horizontal carousel view enables a user to scroll through N options (N≥1 being an integer) for each modality of the trip (e.g., a flight segment, a tourist attraction, a lodging, a restaurant, an activity, etc.), and then select one of the options.
In an example, N can be dynamically selected based on how confidently the backend computation engine is able to match options with the user profile and parameters.
In another example, the N options can be similar options, based on the user's preferences, so that the user can choose the best option for that trip.
In yet another example, the N options can be disparate (or dissimilar) options in the case that a user preference or a user profile is not available. This allows the user to pick the most appropriate type of that modality, and at which point a different set of N similar options for that selected type may be displayed.
In yet another example, the user may have stated an explicit preference (e.g., a flight segment that is constrained by work commitments), in which case only a single option (N=1) is displayed and pinned to the timeline.

In some embodiments, the user can remove an option from the horizontal carousel and the backend computation engine will replace that with another alternative. In an example, the user interface can be configured such that the view of the horizontal carousel loops around, i.e., swiping past the last of N options results in the first of the N options being shown.

In some embodiments, the user can choose to explore more options using the last card at the end of the carousel (e.g., an “explore more options” tile as illustrated in FIG. 14). When the user enters the explore view this way, the explore view is populated with options that are applicable to the context and modality of that trip stop, instead of the general trips and experiences.

In some embodiments, the vertical timeline view and the horizontal carousel view can be dynamically updated based on choices made in either the timeline or the carousel. In other embodiments, the options on a subsequent horizontal carousel view can be dynamically updated based on choices made in a previous horizontal carousel view. Machine learning algorithms can be leveraged to optimize the trip planning process, therein providing these dynamic updates, and transportation options and logistics.
In an example, if a particular accommodation is selected, then the dining options can be updated to provide restaurants closer to the location of the selected lodgings. The machine learning algorithms can automatically add transportation options from the location to the restaurant and, based on historical traffic data, suggest a time to leave the hotel.
In another example, if the itinerary includes two tourist attractions and a subsequent lodging, the lodging choices may have been selected to be closer to the second of the two tourist attractions. However, if the second tourist attraction is removed from the itinerary, then the accommodation choices may be updated to be closer to the first (or remaining) tourist attraction. In this manner, the machine learning algorithms can dynamically update the available options based on user choices.
In yet another example, the user can make selections on two separate horizontal carousels (e.g., two tourist attractions) and the vertical timeline can dynamically update to provide transportation means and/or logistics to get between the stops.
In yet another example, the explore view (e.g., illustrated in FIG. 9B) can be used to enable a user to input a query in natural language in order to find a match. For example, the user can switch to the explore view through the last card on the carousel, and then say “newly opened Thai restaurant that is kid friendly” to find a specific type of restaurant near the location of the other trip stops.

In some embodiments, the vertical timeline allows the user to add a stop for a particular day. Furthermore, the user interface can be configured to provide drag-and-drop interactions for the stops within a single day and across multiple days of a trip.

In some embodiments, customized user-created stops from a previous itinerary or from the user's profile or preferences (e.g., finding a daycare prior to a work meeting, afternoon naptime for a child, etc.) can be inserted into the itinerary.

In some embodiments, the user can indicate a high-level preference for the trip (e.g., minimize transit time, minimize expense, maximize time at tourist attractions) and the horizontal carousels can be updated as required. In other embodiments, the preference may apply only to certain types of stops (e.g., minimize cost spent on food and restaurants), and the corresponding horizontal carousels can be updated to reflect this preference.

In some embodiments, the planning component of the integrated platform can be configured to switch between a timeline view and a map view. The map view would allow a user to see if there are any points of interest between two existing stops, and if one were found, it could be selected in the map view, which would automatically insert it into the vertical timeline view and update the neighboring stops to accommodate for this additional stop. In an example, a previous selection of a neighboring stop may be reverted and available options presented again (and wherein the previous selection could be flagged) because the new stop was added.

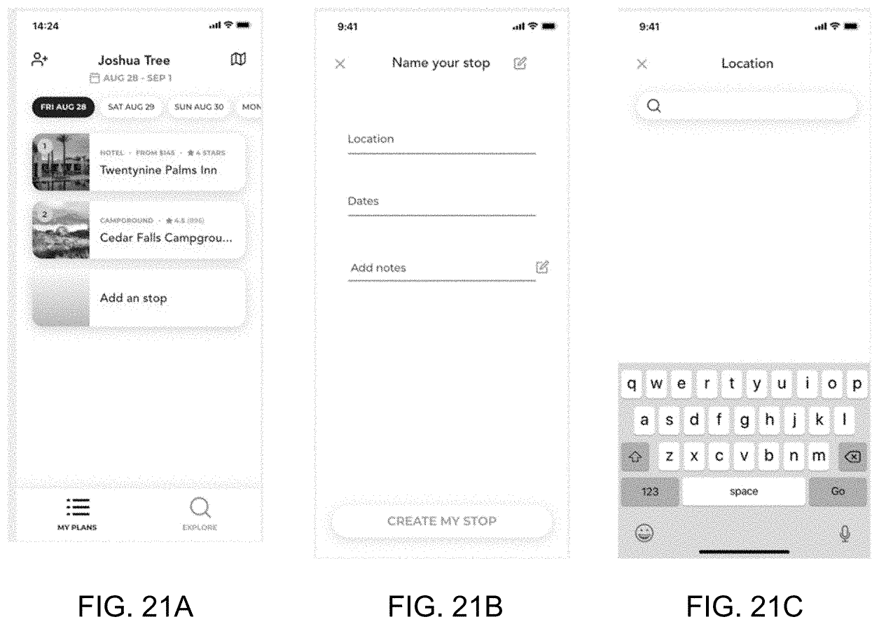

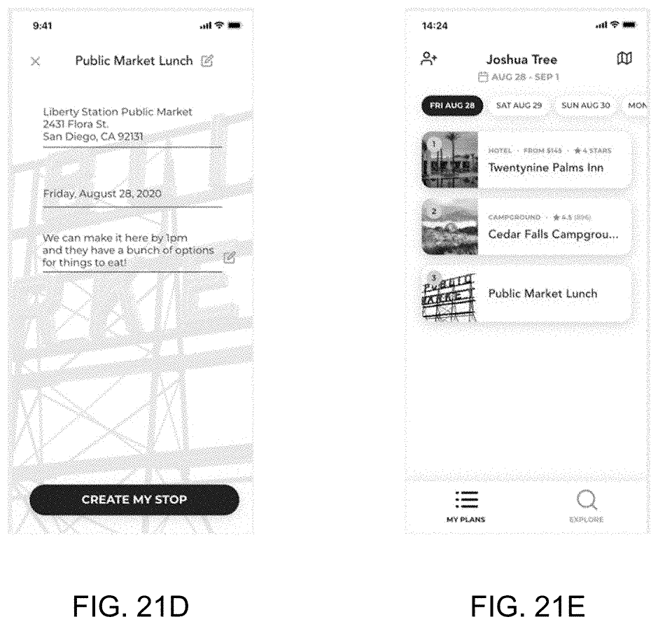

In some embodiments, and as discussed earlier, the user can manually add a stop if they do not find an option in the exploration component that they have already in mind. An example of this process is illustrated in FIGS. 21A-21E. As shown therein, the user first decides to add a stop to an existing itinerary (FIG. 21A), and can add a custom-defined stop (FIG. 21B) using the keyboard (FIG. 21C). The custom-defined stop, which includes a name, address, date and notes (FIG. 21D), can now be created and added to the itinerary (FIG. 21E).

4.1 Examples of Using Anchors for Planning

In some embodiments, the planning element of a trip can be organized using one or more spatial and temporal anchors. As discussed previously, an anchor is a geolocation associated with stops in the trip, e.g., a conference or convention center for a business trip, one or more tourist attractions or friends' houses for a family vacation. Embodiments of the disclosed technology optimize the travel experience around one or more anchors specified by the user.

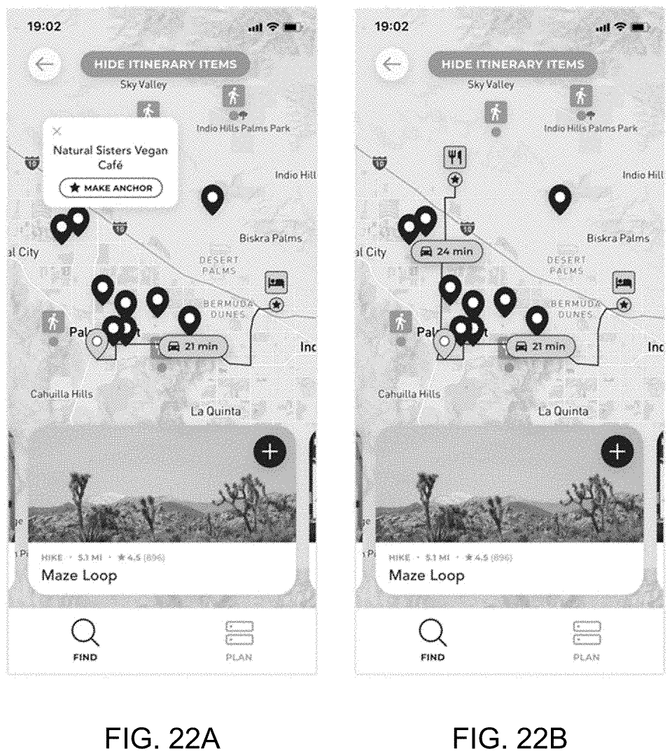

FIGS. 22A and 22B illustrate an example of setting one or more anchors in the user interface. As shown therein, the GUI will display travel information to the anchor locations from all the options in the map.

In some embodiments, the user interface can be configured to enable a user to pin or input an anchor location or an anchor time for a trip stop that is not flexible, and other stops and modalities are planned and organized around the specified anchor location and/or time.

In addition to organizing trips and vacations, the anchor concept may be used to organize local and/or weekend trips by using a user's home as a spatial anchor and a user's schedule as a temporal anchor.

4.2 Examples of Supporting Multiple Users and Collaboration

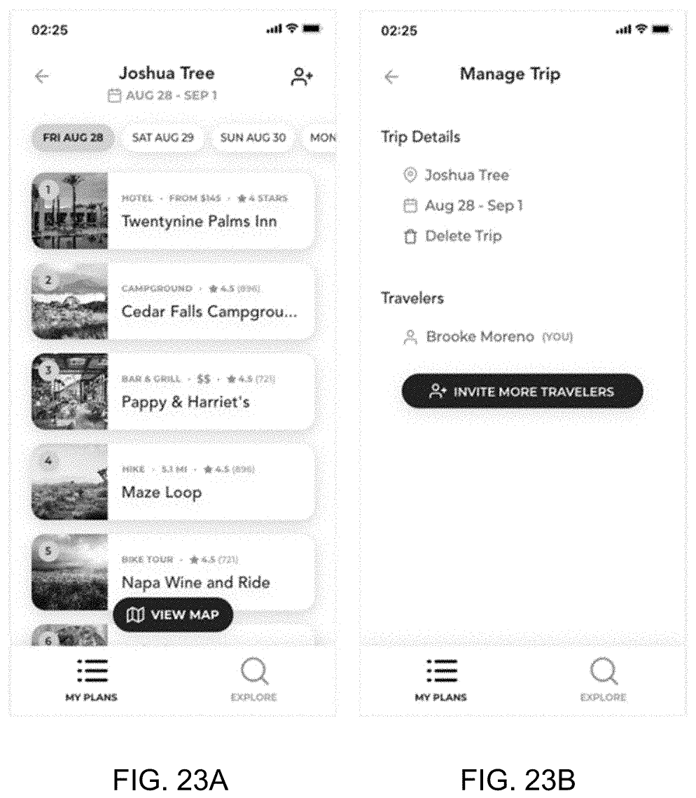

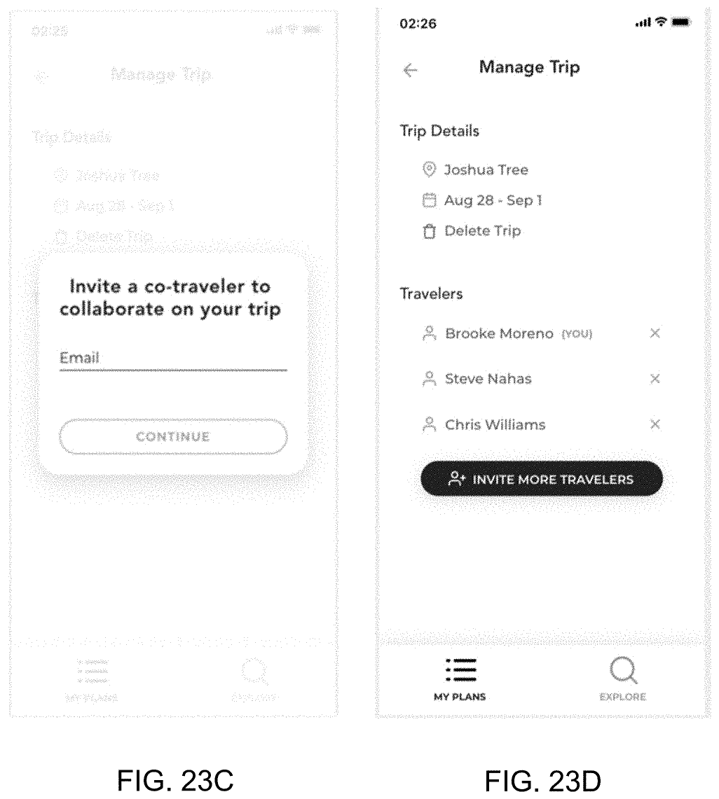

In some embodiments, during the planning phase, the integrated platform can enable the users to share a trip with other co-travelers to collaborate on trip planning, as illustrated in FIGS. 23A-23D. As shown therein, the user viewing a specific itinerary (FIG. 23A) can select one or more users (FIGS. 23B-23C) so that they too can view the itinerary (FIG. 23D). In an example, the co-travelers can also make changes to the trip. In another example, the co-travelers can also communicate with each other via messaging and generate quizzes or polls that the other users on the trip can engage with.

In some embodiments, the trip for multiple users can be coordinated by a single trip administrator; alternatively, two or more users can act as administrators. The integrated platform can be configured to operate in “administrator mode” wherein one or more administrators can determine which of the available options should be selected. In another example, it may operate in “consensus mode” wherein all the users can collaborate (e.g., rank the available options) in order to determine which option for a particular stop should be selected. In yet another example, the integrated platform can operate in “majority mode” wherein a simple majority of users is required to select from amongst the available options. For example, a “like” or a thumbs-up may indicate a preference for a particular option, and the option with the most signals of agreement is selected for the multiple users for the common portion of the trip. Once this has been finalized, the choices for any preceding and subsequent events will be automatically updated to optimize for the selection that has just been made.

In some embodiments, the integrated platform enables the multiple users to split-up expenses for the common portion of the trip. In an example, the cost of hotel rooms and group dinners can be split between all the users. In another example, the receipts can be split to more accurately reflect the spending by each user for business and/or leisure portions of the trip.

In some embodiments, a booked trip or a past trip can be shared with other users for them to incorporate into their future trips. In other embodiments, the booked trip or past trip can be shared via a third-party service (e.g., Facebook, Instagram, etc.) that prompts the other user to install the integrated travel system application, if it is not installed on their device or they do not have an account, to view these ideas and plan their own trips.

5 Examples of Booking Elements of a Trip

In some embodiments, once the user has finalized their choices, the user interface can be configured to display booking buttons to book various components (or modalities) of the trip that are bookable (in comparison to some trip components that are free to visit and to see, etc.). Alternatively, any components with flexible cancellation policies (e.g., car rentals, restaurant reservations) can be automatically booked without explicit user interaction. Once the booking is complete, any components that need an additional transactional step are completed. In some embodiments, information for one or more credit cards that has been stored or that has been input once can be used to complete all the transactions, thereby reducing the complexity and overhead of the booking process for the user. Once the transactions are finalized, the additional options that were not selected are removed in the horizontal carousels.

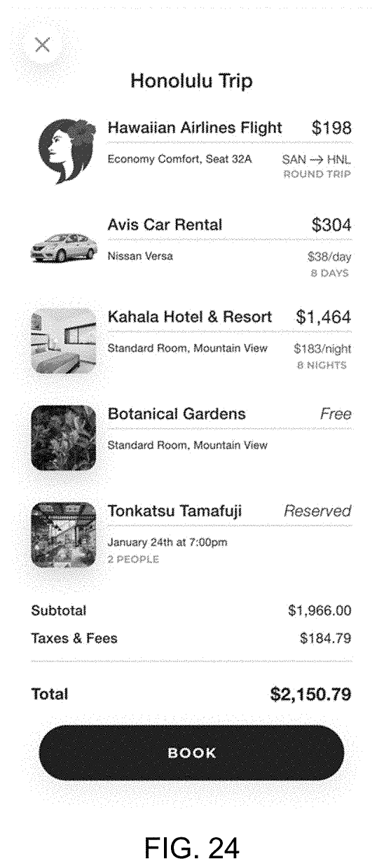

In some embodiments, as the user makes bookable selections from the exploring component for each trip modality (e.g., as illustrated in FIG. 14, 19A, 19B or 23A), the selected components may be added to a shopping cart. Once all the options have been selected, the user can view the shopping cart, illustrated in FIG. 24, before making the final booking.

In some embodiments, the bookable and reservable options could include hotels, vacation rentals, flights, car rentals, restaurants, tours and attractions. Booking support for these options comes from a variety of providers, and the integrated travel platform is configured to use a variety of booking Application Programming Interfaces (APIs) and send booking details and corresponding payment methods to make the booking requests. The user only needs to provide the payment method(s) once, instead of providing one or more payment methods to each of the multiple booking providers. The user can view all reservations at one place. For booking options that can be canceled and/or modified, the integrated travel platform can support the user to cancel or modify the reservations accordingly.

In some embodiments, the finalized itinerary (e.g., including confirmation numbers and reservation details for each stop in the itinerary) can be followed during the trip and shared with other users. The sharing access is configurable, and thus the costs of one or more stops can be shared with some users, but only the travel itinerary can be shared with other users.

6 Examples and Embodiments of the Disclosed Technology

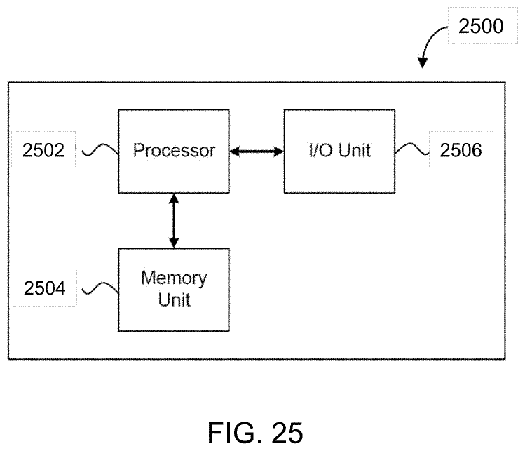

FIG. 25 shows a block diagram of an example embodiment of a device (or apparatus, hardware device or implementation) 2500 that implements the disclosed technology. The device includes a processor 2502 in communication with a memory unit 2504 and an input/output (I/O) unit 2506. The processor 2502 is configured to process data, and the memory unit 2504 is in communication with the processor to store and/or buffer the data. To support various functions of the device, the processor can be included to interface with and control operations of other devices, e.g., via the I/O unit 2506.

In various implementations, the processor 2502 can include one or more processors, e.g., including but not limited to microprocessors such as a central processing unit (CPU), microcontrollers, or the like. The memory unit 2504 can include and store processor-executable code, which when executed by the processor, configures the device to perform various operations, e.g., such as receiving information, commands, and/or data, processing information and data, and transmitting or providing information/data to another device. The memory unit can store other information and data, such as instructions, software, values, images, and other data processed or referenced by processor. For example, various types of Random Access Memory (RAM) devices, Read Only Memory (ROM) devices, Flash Memory devices, and other suitable storage media can be used to implement storage functions of memory unit. In some implementations, the device includes an input/output unit (I/O) 2506 to interface the processor and/or memory unit to other modules, units or devices associated with the system, and/or external devices. For example, the I/O unit can connect to an external interface, source of data storage, or display device. Various types of wired or wireless interfaces compatible with typical data communication standards, such as Universal Serial Bus (USB), IEEE 1394 (FireWire), Bluetooth, Bluetooth low energy (BLE), ZigBee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces, can be used to communicate data with the device via the I/O unit. In some implementations, for example, the device 2500 includes a wireless communications unit, e.g., such as a transmitter (Tx) or a transmitter/receiver (Tx/Rx) unit. In such implementations, for example, the I/O unit can interface the processor and memory unit with the wireless communications unit to utilize various types of wireless interfaces, such as the examples described above. The I/O unit can interface with other external interfaces, sources of data storage, and/or visual or audio display devices, etc. to retrieve and transfer data and information that can be processed by the processor, stored in the memory unit, or exhibited on an output unit of a user device (e.g., display screen of a computing device) or an external device.

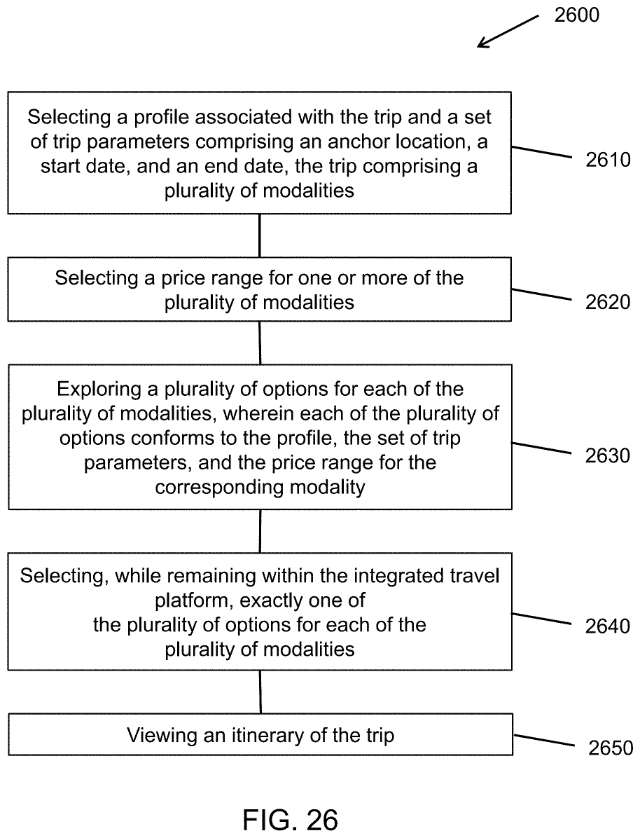

FIG. 26 illustrates a flowchart of an example method for using an integrated travel platform. The method 2600 includes, at operation 2610, selecting a profile associated with the trip and a set of trip parameters comprising an anchor location, a start date, and an end date, the trip comprising a plurality of modalities.

The method 2600 includes, at operation 2620, selecting a price range for one or more of the plurality of modalities.

The method 2600 includes, at operation 2630, exploring a plurality of options for each of the plurality of modalities, wherein each of the plurality of options conforms to the profile, the set of trip parameters, and the price range for the corresponding modality.

The method 2600 includes, at operation 2640, selecting, while remaining within the integrated travel platform, exactly one of the plurality of options for each of the plurality of modalities.

The method 2600 includes, at operation 2650, viewing an itinerary of the trip.

In some embodiments, exploring the plurality of options for a particular modality comprises scrolling through a list comprising the plurality of options.

In some embodiments, exploring the plurality of options for a particular modality comprises viewing a subset of the plurality of options on a map, and wherein each option of the subset of the plurality of options is within a predetermined distance from the anchor location.

In some embodiments, selecting the exactly one option comprises selecting, using the map, an option from the subset of the plurality of options to be added to the itinerary of the trip.

In some embodiments, the profile is generated based on a visual quiz that uses visual representations of options for a modality of the plurality of modalities to gauge a user preference for the modality.

In some embodiments, the profile comprises a plurality of features, and the method 2400 further comprises selecting one or more of the plurality of features, wherein each of the plurality of options comprises each of the one or more of the plurality of features that were selected.

In some embodiments, the profile is a business profile and the anchor location is a convention center. In other embodiments, the profile is a leisure or family profile and the anchor location is a tourist attraction.

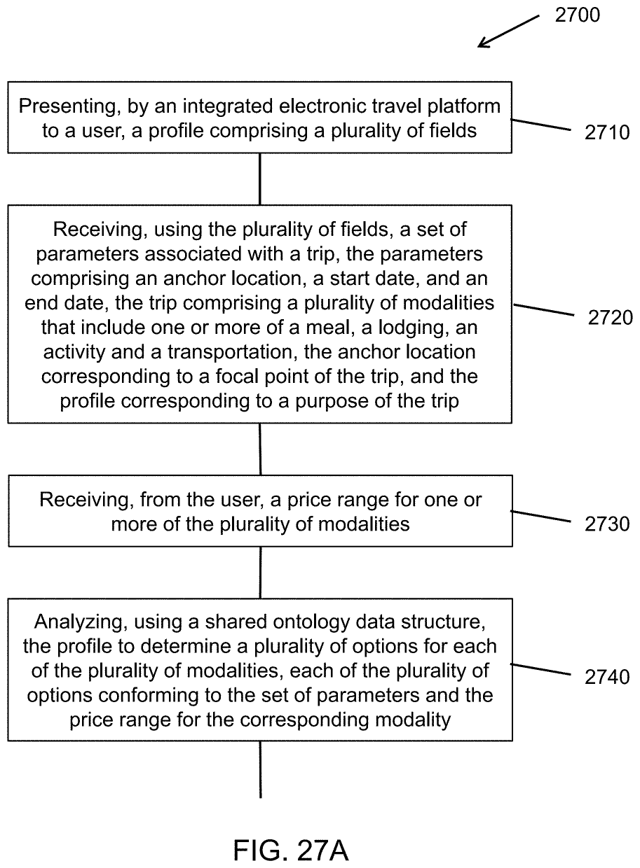

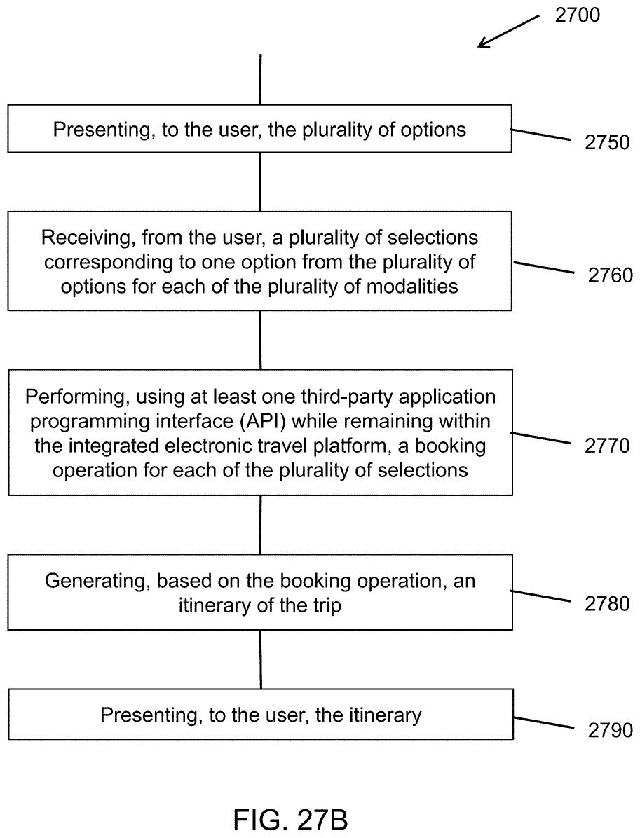

FIGS. 27A and 27B illustrate a flowchart of an example method for improving travel planning, viewing, and booking using an integrated travel platform. The method 2700 includes, at operation 2710, presenting, by an integrated electronic travel platform to a user, a profile comprising a plurality of fields.

The method 2700 includes, at operation 2720, receiving, using the plurality of fields, a set of parameters associated with a trip, the parameters comprising an anchor location, a start date, and an end date, the trip comprising a plurality of modalities that include one or more of a meal, a lodging, an activity and a transportation, the anchor location corresponding to a focal point of the trip, and the profile corresponding to a purpose of the trip.

The method 2700 includes, at operation 2730, receiving, from the user, a price range for one or more of the plurality of modalities.

The method 2700 includes, at operation 2740, analyzing, using a shared ontology data structure or a neural network, the profile to determine a plurality of options for each of the plurality of modalities, each of the plurality of options conforming to the set of parameters and the price range for the corresponding modality.

The method 2700 includes, at operation 2750, presenting the plurality of options.

The method 2700 includes, at operation 2760, receiving, from the user, a plurality of selections corresponding to one option from the plurality of options for each of the plurality of modalities.

The method 2700 includes, at operation 2770, performing, using at least one third-party application programming interface (API) while remaining within the integrated electronic travel platform, a booking operation for each of the plurality of selections.

The method 2700 includes, at operation 2780, generating, based on the booking operation, an itinerary of the trip.

The method 2700 includes, at operation 2790, presenting, to the user, the itinerary.

In some embodiments, the shared ontology data structure (e.g., as illustrated in FIGS. 5A and 5B) represents a plurality of properties and a plurality of features from the perspective of the user and from a perspective of the trip, wherein a first set of relations is defined between the user and at least one of the plurality of properties, a second set of relations is defined between the trip and at least one of the plurality of features, and a third set of relations is defined between the at least one of the plurality of properties and the at least one plurality of features.

In some embodiments, the booking operation comprises using a first third-party API to confirm an availability of each of the plurality of selections, and using a second third-party API to provide payment information associated with the user to reserve or purchase each of the plurality of selections, wherein the payment information is stored within the integrated travel platform subsequent to being input by the user.

In some embodiments, presenting the plurality of options for a particular modality comprises presenting a list comprising the plurality of options.

In some embodiments, presenting the plurality of options for a particular modality comprises presenting a subset of the plurality of options on a map, and wherein each option of the subset of the plurality of options is within a predetermined distance from the anchor location.

In some embodiments, receiving a selection corresponding to the one option comprises receiving an option from the subset of the plurality of options to be added to the itinerary of the trip.

In some embodiments, the profile is based on a visual quiz that uses visual representations of options for a modality of the plurality of modalities to gauge a user preference for the modality.

Embodiments of the disclosed technology further describe a first screen, comprising a plurality of fields configured to receive each of a set of parameters associated with a trip, the parameters comprising an anchor location, a start date, and an end date, the trip comprising a plurality of modalities that include one or more of a meal, a lodging, an activity and a transportation, wherein a profile comprises the plurality of fields, and wherein the anchor location corresponds to a focal point of the trip and the profile corresponds to a purpose of the trip, a slider to select a price range for one or more of the plurality of modalities, and one or more buttons to select a profile associated with the trip, a second screen, comprising a plurality of options for a corresponding modality, wherein each of the plurality of options conforms to the set of parameters and the price range for the corresponding modality, wherein the plurality of options are determined based on a neural network, and wherein the second screen enables a selection of one option of the plurality of options for each of the plurality of modalities, a third screen, comprising a list comprising the one option of the plurality of options selected for each of the plurality of modalities, the list enabling a user to perform a booking operation using at least one third-party application programming interface (API) while remaining within the integrated electronic travel platform, wherein at least one entry of the list comprises a price for the corresponding modality, and a fourth screen, comprising a vertical timeline to view an itinerary of the trip, wherein the booking operation is performed prior to viewing the itinerary of the trip.

In some embodiments, a first of the set of parameters is input by a user using an on-screen keyboard, and wherein a second of the set of parameter is input by the user by selection from a list.

In some embodiments, the booking operation comprises using a first third-party API to confirm an availability of each of the plurality of selections, and using a second third-party API to provide payment information associated with the user to reserve or purchase each of the plurality of selections, wherein the payment information is stored within the integrated travel platform subsequent to being input by the user.

In some embodiments, the plurality of options for the corresponding modality are displayed in a list view.

In some embodiments, a subset of the one or more options for the corresponding modality are displayed in a map view, and wherein each option of the subset is within a predetermined distance from the anchor location.

In some embodiments, the graphical user interface further comprises a fifth screen, comprising a plurality of visual representations, corresponding to options for one of the plurality of modalities, that enables the integrated electronic travel platform to gauge a user preference for the corresponding modality.

In some embodiments, the second screen displays the one or more options for the corresponding modality in a condensed form to enable the one or more options to be compared.

In some embodiments, at least one of the set of trip parameters and at least one of the exactly one of the one or more options for a corresponding modality is selected from a prepackaged itinerary.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). In an example, the binary neural network may be implemented on an ASIC or FPGA.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for improving travel planning, viewing, and booking, comprising:
presenting, by an integrated electronic travel platform to a user, a profile comprising a plurality of fields;
receiving, using the plurality of fields, a set of parameters associated with a trip, the parameters comprising an anchor location, a start date, and an end date, the trip comprising a plurality of modalities that include one or more of a meal, a lodging, an activity and a transportation, wherein the anchor location corresponds to a focal point of the trip and the profile corresponds to a purpose of the trip;
receiving, from the user, a price range for one or more of the plurality of modalities;
analyzing, using a shared ontology data structure, the profile to determine a plurality of options for each of the plurality of modalities, wherein each of the plurality of options conforms to the set of parameters and the price range for the corresponding modality;
presenting, to the user, the plurality of options;
receiving, from the user, a plurality of selections corresponding to one option from the plurality of options for each of the plurality of modalities;
performing, using at least one third-party application programming interface (API) while remaining within the integrated electronic travel platform, a booking operation for each of the plurality of selections;
generating, based on the booking operation, an itinerary of the trip;
presenting, to the user, the itinerary.

2. The method of claim 1, wherein the shared ontology data structure represents a plurality of properties and a plurality of features from the perspective of the user and from a perspective of the trip, wherein a first set of relations is defined between the user and at least one of the plurality of properties, a second set of relations is defined between the trip and at least one of the plurality of features, and a third set of relations is defined between the at least one of the plurality of properties and the at least one plurality of features.

3. The method of claim 1, wherein the booking operation comprises:
using a first third-party API to confirm an availability of each of the plurality of selections; and
using a second third-party API to provide payment information associated with the user to reserve or purchase each of the plurality of selections,
wherein the payment information is stored within the integrated travel platform subsequent to being input by the user.

4. The method of claim 1, wherein presenting the plurality of options for a particular modality comprises presenting a list comprising the plurality of options.

5. The method of claim 1, wherein presenting the plurality of options for a particular modality comprises presenting a subset of the plurality of options on a map, and wherein each option of the subset of the plurality of options is within a predetermined distance from the anchor location.

6. The method of claim 5, wherein receiving a selection corresponding to the one option comprises:
receiving an option from the subset of the plurality of options to be added to the itinerary of the trip.

7. The method of claim 1, wherein the profile is based on a visual quiz that uses visual representations of options for a modality of the plurality of modalities to gauge a user preference for the modality.

8. A graphical user interface in an integrated electronic travel platform, comprising:
a first screen, comprising:
a plurality of fields configured to receive each of a set of parameters associated with a trip, the parameters comprising an anchor location, a start date, and an end date, the trip comprising a plurality of modalities that include one or more of a meal, a lodging, an activity and a transportation, wherein a profile comprises the plurality of fields, and wherein the anchor location corresponds to a focal point of the trip and the profile corresponds to a purpose of the trip,
a slider to select a price range for one or more of the plurality of modalities, and
one or more buttons to select a profile associated with the trip;
a second screen, comprising:
a plurality of options for a corresponding modality, wherein each of the plurality of options conforms to the set of parameters and the price range for the corresponding modality,
wherein the plurality of options are determined based on a neural network, and
wherein the second screen enables a selection of one option of the plurality of options for each of the plurality of modalities;
a third screen, comprising:
a list comprising the one option of the plurality of options selected for each of the plurality of modalities, the list enabling a user to perform a booking operation using at least one third-party application programming interface (API) while remaining within the integrated electronic travel platform, wherein at least one entry of the list comprises a price for the corresponding modality; and
a fourth screen, comprising:
a vertical timeline to view an itinerary of the trip,
wherein the booking operation is performed prior to viewing the itinerary of the trip.

9. The graphical user interface of claim 8, wherein a first of the set of parameters is input by a user using an on-screen keyboard, and wherein a second of the set of parameter is input by the user by selection from a list.

10. The graphical user interface of claim 8, wherein the booking operation comprises:
using a first third-party API to confirm an availability of each of the plurality of selections; and
using a second third-party API to provide payment information associated with the user to reserve or purchase each of the plurality of selections,
wherein the payment information is stored within the integrated travel platform subsequent to being input by the user.

11. The graphical user interface of claim 8, wherein the plurality of options for the corresponding modality are displayed in a list view.

12. The graphical user interface of claim 8, wherein a subset of the one or more options for the corresponding modality are displayed in a map view, and wherein each option of the subset is within a predetermined distance from the anchor location.

13. The graphical user interface of claim 8, further comprising:
a fifth screen, comprising:
a plurality of visual representations, corresponding to options for one of the plurality of modalities, that enables the integrated electronic travel platform to gauge a user preference for the corresponding modality.

14. The graphical user interface of claim 8, wherein the second screen displays the one or more options for the corresponding modality in a condensed form to enable the one or more options to be compared.

15. The graphical user interface of claim 14, wherein at least one of the set of trip parameters and at least one of the exactly one of the one or more options for a corresponding modality is selected from a prepackaged itinerary.

16. A non-transitory computer readable storage medium having instructions stored thereupon, the instructions, when executed by a processor, causing the processor to implement a method for improving travel planning, viewing, and booking, comprising:
instructions for presenting, by an integrated electronic travel platform to a user, a profile comprising a plurality of fields;
instructions for receiving, using the plurality of fields, a set of parameters associated with a trip, the parameters comprising an anchor location, a start date, and an end date, the trip comprising a plurality of modalities that include one or more of a meal, a lodging, an activity and a transportation, wherein the anchor location corresponds to a focal point of the trip and the profile corresponds to a purpose of the trip;
instructions for receiving, from the user, a price range for one or more of the plurality of modalities;
instructions for analyzing, using a shared ontology data structure or a neural network, the profile to determine a plurality of options for each of the plurality of modalities, wherein each of the plurality of options conforms to the set of parameters and the price range for the corresponding modality;
instructions for presenting, to the user, the plurality of options;
instructions for receiving, from the user, a plurality of selections corresponding to one option from the plurality of options for each of the plurality of modalities;
instructions for performing, using at least one third-party application programming interface (API) while remaining within the integrated electronic travel platform, a booking operation for each of the plurality of selections;
instructions for generating, based on the booking operation, an itinerary of the trip;
instructions for presenting, to the user, the itinerary.

17. The non-transitory computer readable storage medium of claim 16, wherein the instructions for presenting the plurality of options for a particular modality comprises:
instructions for presenting a list comprising the plurality of options.

18. The non-transitory computer readable storage medium of claim 16, wherein the instructions for presenting the plurality of options for a particular modality comprises:
instructions for presenting a subset of the plurality of options on a map, wherein each option of the subset of the plurality of options is within a predetermined distance from the anchor location.

19. The non-transitory computer readable storage medium of claim 16, wherein the profile is generated based on a visual quiz that uses visual representations of options for a modality of the plurality of modalities to gauge a user preference for the modality.

20. The non-transitory computer readable storage medium of claim 16, wherein the profile is a business profile and the anchor location is a convention center, or wherein the profile is a leisure or family profile and the anchor location is a tourist attraction.
